(19) United States
(12) Patent Application Publication
(10) Pub. No.: US 2023/0048630 A1
(43) Pub. Date: Feb. 16, 2023

(54) FOOD COMMINUTION DEVICE

(71) Applicant: Excellent Market Ltd., Hong Kong (HK)

(72) Inventor: Cedomir Repac, Brechen (DE)

(21) Appl. No.: 17/817,763

(22) Filed: Aug. 5, 2022

(30) Foreign Application Priority Data
Aug. 5, 2021 (LU) 500516

(51) Int. Cl. B26D 1/00; B26D 3/18; B26D 7/06

(52) U.S. Cl. CPC B26D 1/0006; B26D 3/185; B26D 7/0608; B26D 2210/02; B26D 2001/0073

(57) ABSTRACT

The food comminution device includes a cutting part (3), a spiral cutting part (6) and a rotary drive (5), wherein food items (4) for comminution can, in order to be comminuted, be selectively pushed through the cutting part (3) or rotated by means of the rotary drive relative to a spiral cutting part (6). The food comminution device further includes an actuating part (1) and a base part (2) which has a cutting part (3), wherein the actuating part (1) is movably connectable to the base part (2) such that food items (4) for comminution can be pushed through the cutting part (3) by means of a movement of the actuating part (1) relative to the base part (2). The actuating part (1) has a rotary drive by means of which a food item (4) for comminution can be rotated relative to a spiral cutting part (6).

### CROSS-REFERENCE TO RELATED APPLICATION

The present application claims priority to Luxembourg Application No. 500516, filed Aug. 5, 2021, the entire disclosure of which is incorporated herein by reference.

### FIELD OF THE DISCLOSURE

The invention relates to a food comminution device. The invention relates in particular to a food comminution device having an actuating part and having a base part which has a cutting part, wherein the actuating part is movably connectable to the base part such that food items for comminution can be pushed through the cutting part by means of a movement of the actuating part relative to the base part.

### BACKGROUND OF THE DISCLOSURE

DE 10 2009 023 167 A1 has disclosed a device for cutting food items such as fruit and vegetables, having a cutting part, which has multiple cutting edges, and having an actuating part, which cutting part and actuating part are mounted such that they can be pivoted against one another. In order to cut the item for cutting, the actuating part is pushed against the cutting part, wherein the actuating part has a plunger that pushes the item for cutting through the cutting part, wherein the cutting edges protrude into corresponding depressions of the plunger. The cutting part has a cutting frame in which cutting blades are held. The device furthermore has a cover part for attachment to a receiving container for the cut items for cutting, wherein the cover part has an opening that forms a passage for the cut items for cutting.

DE 21 2005 000 048 U1 has disclosed a food processing device having a container with a base and with a multiplicity of upwardly extending side walls, wherein the side walls have an upper end and a base end, and wherein the container has an upper end and a base end, and having a shell which is fastened to the container closer to the upper end of the container than to the base end of the container, wherein the shell defines an inner region within an area that is defined by the side walls of the container, wherein the shell has a multiplicity of cutting edges. The food processing device furthermore has a cover that is attached pivotably to the container, wherein the cover has a multiplicity of projections which are configured in terms of their size and shape such that they are received between the multiplicity of cutting edges when the cover is closed.

It is the object of the present invention to specify a food comminution device which allows food items for comminution to be quickly and easily cut into a different shape, in particular a shape that is suitable for garnishing dishes.

### SUMMARY OF THE DISCLOSURE

According to the invention, a protective housing for a microtome blade, an arrangement having a protective housing and a microtome blade, and a microtome blade holder having the features of the independent claims are proposed. Advantageous configurations are the subject matter of the dependent claims and the following description.

The object is achieved by means of a food comminution device having a cutting part, a spiral cutting part and a rotary drive, in the case of which food items for comminution can, in order to be comminuted, be selectively pushed through the cutting part or rotated by means of the rotary drive relative to a spiral cutting part.

The object is alternatively achieved by means of a food comminution device having an actuating part and having a base part which has a cutting part, wherein the actuating part is movably connectable to the base part such that food items for comminution can be pushed through the cutting part by means of a movement of the actuating part relative to the base part, which food comminution device is characterized in that the actuating part has a rotary drive by means of which a food item for comminution can be rotated relative to a spiral cutting part.

The invention has the very particular advantage that food items for comminution, such as cucumbers, carrots or radishes, can not only be cut into slices or sticks by being pushed through a cutting part, but can alternatively also be easily and quickly cut into spiral-shaped garlands using the same food comminution device.

The food comminution device, in particular the base part of the food comminution device, may advantageously have a receptacle into which selectively the cutting part or the spiral cutting part can be inserted. Such an embodiment has the very particular advantage of allowing an uncomplicated and quick exchange of the cutting part for the spiral cutting part or of the spiral cutting part for the cutting part.

In a particularly advantageous embodiment, the cutting part can be inserted into the receptacle without the use of tools. Alternatively or in addition, provision may advantageously be made for the cutting part to be removable from the receptacle again without the use of tools and non-destructively. The same alternatively or additionally also applies analogously to the spiral cutting part. Owing to exchangeability without the use of tools, the food comminution device according to the invention can be easily and quickly converted.

In a particular embodiment, the cutting part and/or the spiral cutting part are inserted with latching and/or clamping action into the receptacle. In this way, it can advantageously be achieved that the cutting part or the spiral cutting part does not inadvertently become detached from the receptacle.

In a very particularly advantageous embodiment, the food comminution device, in particular the base part of the food comminution device, has a container. The container may in particular serve for collecting the comminuted food item.

The receptacle may advantageously be formed in the region of an opening of the container. Alternatively or in addition, provision may advantageously be made for the receptacle to be formed at least partially by the edge region, which surrounds an opening, of the container. Such an embodiment is particularly easy to handle. Furthermore, there is the particular advantage of being able to use the container directly as a storage container for the comminuted food item by virtue of the cutting part or the spiral cutting part being removed from the receptacle and a cover being placed on instead. In this respect, it is particularly advantageous if the food comminution device has multiple containers that can be successively filled with comminuted food items in the manner according to the invention.

In a particular embodiment, the cutting part, when inserted into the receptacle, or the spiral cutting part, when inserted into the receptacle, covers the opening of the container, in particular completely. Such an embodiment is particularly reliable. In particular, in the case of such an embodiment, it is substantially ensured that no comminuted food items inadvertently pass out of the container or foreign bodies pass into the container.

In a very robust embodiment that requires particularly few components, the cutting part, when inserted into the receptacle, lies on an edge of the container. In this way, the cutting part is particularly well supported during a comminution process in which the food item for comminution is pushed through the cutting part. The same applies if, instead of the cutting part, the spiral cutting part is inserted into the receptacle such that it lies on the edge of the container.

Alternatively or in addition, provision may advantageously be made for the cutting part, when inserted into the receptacle, and/or the spiral cutting part, when inserted into the receptacle, to partially project into the container. For example, such an embodiment may be implemented by virtue of the cutting part and/or the spiral cutting part having an encircling rabbet. Effective horizontal support of the inserted cutting part or of the spiral cutting part relative to the container is advantageously made possible in this way.

The movable connection of the actuating part to the base part is configured such that a rotation of the actuating part relative to the base part is prevented. In particular if the base part is guided, in particular in linearly displaceable fashion, in the actuating part, provision may advantageously be made for this purpose for the base part to have a non-circular outer contour in horizontal cross section, whilst the actuating part has a non-circular inner contour in horizontal cross section. For example, the base part and/or the actuating part may be of rectangular, in particular square, configuration in horizontal cross section.

The base part and/or the actuating part may very generally be of cylindrical configuration at least in certain sections. In order to prevent a relative rotation of the base part with respect to the actuating part, in particular when the rotary drive is actuated, provision may advantageously be made for the base area of the cylinder to be non-circular.

In an embodiment that can be handled particularly reliably, the food comminution device has an anti-slip element, in particular at a placement surface. In particular, provision may advantageously be made for the base part to have an anti-slip element, in particular at a placement surface. The anti-slip element prevents slippage of the food comminution device on the placement surface on which the food comminution device is used, and in particular makes it possible for the torque that is introduced during use of the rotary drive (for example by way of a hand crank) to be supported on the placement surface.

The anti-slip element may be configured for example as a ring, in particular as an O-ring, or as a pedestal or as a mat or as a grid or as an arrangement of, in particular mutually parallel, strips or as an arrangement of, in particular mutually parallel, strands. For example, the anti-slip element may be configured as a strand or as a ring, in particular as an O-ring, which is recessed into a groove on the underside of the base part so as to partially protrude.

The anti-slip element is preferably produced from plastic material, in particular silicone or rubber. Provision may at least advantageously be made whereby the anti-slip element has an elastic material, in particular silicone or rubber. Such an embodiment has the particular advantage that the placement surface is protected against damage, in particular against scratching. Furthermore, such materials exhibit very good adhesion characteristics in interaction with common placement surfaces, for example a tabletop or a worktop.

The container is preferably at least partially of translucent or transparent configuration. In such an embodiment, the user can directly visually monitor the fill level.

In a very particularly advantageous embodiment, the actuating part is linearly displaceably connectable to the base part. This may be implemented for example by virtue of the actuating part being configured to be slidable, in particular in telescopic fashion, onto the base part. In this way, a reliable, in particular rotationally fixed, movable connection can be quickly and easily produced, which connection can likewise be quickly and easily released again, for example after a comminution process and/or for the introduction of new food items for comminution into the food comminution device.

The actuating part may have a receiving space into which the base part can be at least partially slid, in particular in positively locking fashion and/or along a sliding-in direction. The sliding-in direction may in particular be the direction of the movement of the actuating part relative to the base part by way of which the food item for comminution is pushed through the cutting part.

In one advantageous embodiment, the receiving space is partially delimited by a wall. The wall may advantageously serve for guiding the actuating part relative to the base part. In particular, for this purpose, the shape of the inner contour of the wall of the receiving space and the shape of the outer contour of the base part may be configured to be identical in a plane perpendicular to the sliding-in direction. There is preferably merely a degree of play between the base part and the actuating part in order to allow the actuating part to be easily placed over the base part without becoming jammed.

In order to implement a rotationally fixed movable connection of the actuating part relative to the base part, it is advantageous if the inner contour of the wall of the receiving space and the outer contour of the base part are non-circular in a plane perpendicular to the sliding-in direction. In particular, provision may advantageously be made for the inner contour of the wall of the receiving space and the outer contour of the base part to be rectangular, in particular square, in a plane perpendicular to the sliding-in direction. There are however no fundamental limitations with regard to the shape of the inner contour or the shape of the outer contour.

It is however particularly advantageous if the shape of the inner contour and the shape of the outer contour are rotationally symmetrical in a plane perpendicular to the sliding-in direction, because this allows multiple relative orientations in which the actuating part and the base part can be slid one inside the other, which increases the ease of handling. However, a rotationally asymmetrical shape of the inner contour and a rotationally asymmetrical shape of the outer contour are not fundamentally ruled out.

In a very particularly advantageous embodiment, the wall has at least one aperture and/or one window. Such an embodiment has the particular advantage that the user can see the food item for comminution and/or the cutting part and/or the spiral cutting part during the comminution process. In this way, it is made possible for the user to directly recognize if a problem occurs, for example because the food item for comminution has become jammed.

An aperture furthermore has the very particular advantage of enabling the user to introduce a food item for accommodation into the receiving space before a comminution process. An aperture furthermore has the particular advantage of making it possible for the user, by inserting their fingers through the aperture into the receiving space, to correctly orient and position in the receiving space a food item that has already been introduced into the receiving space, which food item has for example already been introduced through a slide-in opening of the actuating part for the base part.

In a particularly advantageous embodiment, the food comminution device has a pressing plunger against which the food item for comminution bears during a movement of the actuating part relative to the base part for the purposes of pushing said item through the cutting part. The actuating part may in particular have the pressing plunger. The pressing plunger preferably has grooves into which the cutting blades of the cutting part can protrude. It is hereby ensured that the food item for comminution is completely cut, and none of it remains stuck between the cutting blades.

The pressing plunger is preferably configured to be removable. In particular, provision may advantageously be made whereby the pressing plunger is fastened so as to be releasable without the use of tools and/or is fastenable without the use of tools. A removal of the pressing plunger may for example be necessary if it is intended to use the spiral cutting part instead of the cutting part, or if it is intended for a further cutting part to be used instead of the cutting part. For this situation, provision may be made whereby a driver for transmitting a rotational movement from a rotary drive to a food item is installed instead of the pressing plunger.

However, the actuating part may also be configured such that the pressing plunger does not have to be removed when the spiral cutting part is used. For this purpose, provision may for example be made for a driver for transmitting a rotational movement from the rotary drive to a food item to have a shaft by means of which said driver can be coupled onto an output of the rotary drive, wherein the shaft, in the coupled-on state, extends rotatably through the pressing plunger.

In a very particularly advantageous embodiment, the pressing plunger has a coupling element which is configured to interact with a counterpart coupling element of an output of the rotary drive. In such an embodiment, the output functions as a holder for the pressing plunger, wherein it is however preferably the case that no torque is transmitted to the pressing plunger. In particular, in this way, it can advantageously be achieved that the same component is used for the coupling-on of a driver and for the coupling-on of a pressing plunger. The coupling element of the driver and the coupling element of the pressing plunger may in this case be of different configurations. In particular, the coupling element of the pressing plunger may (by contrast to the coupling element of the driver) be configured such that no torque can be transmitted to the pressing plunger.

In a particularly robust embodiment, the food comminution device has a rotary drive housing. In particular, the actuating part may have the rotary drive housing. In particular, a transmission of the rotary drive may be arranged in the rotary drive housing. Furthermore, the rotary drive housing may be configured and arranged so as to at least partially delimit a part of the above-described receiving space.

Provision may very generally advantageously be made for the rotary drive to have a transmission. The transmission may in particular be a spur-gear transmission. There are however no fundamental limitations with regard to the type of transmission.

The use of a transmission has the advantage in particular that the axis of rotation of the driver and thus the axis of rotation of the food item to be comminuted can be arranged so as to be offset in parallel with respect to the axis of rotation of a hand crank. In this way, it is advantageously made possible for the user to position a hand in the axis of rotation of the food item, in order to be able to exert a force in the direction of the spiral cutting part, without impeding a movement of the hand crank. As a result, undesired transverse forces and jamming of the actuating part relative to the base part are effectively prevented.

Furthermore, the transmission may be configured as a step-up transmission or as a step-down transmission in order either to be able to transmit a high torque to the food item, which may be advantageous in particular in the case of hard food items, or in order to be able to achieve a high rotational speed of the food item, in order to be able to cut it quickly into spiral-shaped garlands.

The rotary drive may advantageously be configured as a manually actuatable drive. For example, the rotary drive may be configured as a crank drive or as a pull cord drive.

In one particular embodiment, the rotary drive is configured as a crank drive and has a hand crank which is removable, in particular without the use of tools and/or non-destructively. Such an embodiment has the very particular advantage that the hand crank can be removed if it is intended to use the food comminution device together with the cutting part. If it is intended to use the food comminution device together with the spiral cutting part, the hand crank and be coupled on, preferably by means of a rotationally conjoint plug-type connection and/or a bayonet connection.

The rotary drive may alternatively also be configured as an electric drive. In particular, provision may advantageously be made for the food comminution device to have an electrical energy store, for example a battery, which provides electrical energy for the operation of the rotary drive.

As already mentioned, the food comminution device may have a driver which is couplable or coupled to the rotary drive and by means of which a rotational movement can be transmitted to a food item for comminution. The driver preferably has at least one projection, particular a spike and/or a blade and/or a hook, in order to allow rotationally conjoint coupling to a food item for comminution. The at least one projection can engage into the food item for comminution in order to establish a rotationally conjoint connection with the food item.

For coupling onto the output of the transmission, the driver may advantageously have a coupling element configured as a plug-type element. In particular, provision may advantageously be made whereby the coupling element can be plugged into or onto a counterpart coupling element of the transmission with latching and/or clamping action. The coupling element and the counterpart coupling element are preferably configured such that the driver is couplable to the rotary drive without the use of tools and/or such that the driver is decouplable from the rotary drive without the use of tools and non-destructively.

The cutting part preferably has at least one cutting blade, the cutting blade web of which is arranged in a plane that is oriented in the pushing-through direction, wherein the cutting edge of the cutting blade is preferably at right angles to the pushing-through direction. In particular, the cutting part may have multiple cutting blades that are arranged parallel to one another or in the form of a grid. A cutting part with an arrangement of exclusively parallel cutting blades can be used to cut a food item into slices. A cutting part with a cutting grid can be used to cut a food item into sticks. The cutting blades may for example also be arranged adjacent to one another, but not parallel with respect to one another, in order to cut a food item into wedge-shaped slices. There are no fundamental limitations with regard to the arrangement of the cutting blades.

The cutting edge of the cutting blade may be of straight, curved, undulating or serrated configuration. In particular, the cutting edge of the cutting blade may be adapted to the type of food item for comminution.

An embodiment is particularly advantageous which comprises at least one further cutting part which differs from the cutting part, in particular in the number of cutting blades and/or in the arrangement of the cutting blades and/or in the shape of the cutting blades and/or in the configuration of the cutting edge. The further cutting part may for example be used instead of the cutting part if it is intended to cut a different food item and/or if it is intended to cut the food item into differently shaped pieces. For this purpose, it is advantageously possible in particular for a further pressing plunger to be provided, which is adapted to the further cutting part and which can be inserted in exchange for the pressing plunger, preferably without the use of tools.

The spiral cutting part preferably has at least one, in particular radially oriented, blade. The at least one blade is preferably positioned and oriented so as to cut at least one spiral-shaped garland from a food item that is set in rotation by means of the rotary drive. Here, it is very particularly advantageous if the blade extends as far as the axis of rotation of the food item and/or of the driver. This has the particular advantage that the food item is reliably completely cut into spiral-shaped garlands. It is however also possible for there to be a small spacing between the blade and the axis of rotation of the food item and/or of the driver. In particular in an embodiment which has multiple radially oriented blades, in particular exactly two or exactly four blades, a small radial spacing of the blades to the axis of rotation can be provided without the cutting performance being significantly impaired.

With an embodiment in which the spiral cutting part has multiple, in particular exactly two or exactly four, blades arranged so as to be distributed uniformly in a tangential direction, particularly high cutting performance is achieved in the case of cutting into spiral-shaped garlands, because multiple spiral-shaped garlands are peeled off simultaneously as the food item for comminution rotates.

In a very particularly advantageous embodiment, the spiral cutting part has an in particular conical spiral cutting part receiving space for the introduction of food items, on the receiving space wall of which the at least one blade is arranged. The spiral cutting part receiving space is preferably oriented such that the cone central axis corresponds to the axis of rotation. Such an embodiment has the very particular advantage that the food item for comminution is automatically aligned and centred with the axis of rotation.

The spiral cutting part may very generally be configured to simultaneously cut multiple spiral-shaped garlands from a food item. This may, as already mentioned, be realized by virtue of the spiral cutting part having multiple radially oriented blades, which simultaneously cut in each case one spiral-shaped garland from the food item. Alternatively or in addition, the spiral cutting part may have further cutting blades which are arranged perpendicular to the at least one blade and by means of which the garland that has been cut off or is to be cut off by means of the blade is divided up (along its direction of longitudinal extent) into multiple spiral-shaped garlands.

In a very particularly advantageous embodiment, at least one further spiral cutting part is provided which differs from the spiral cutting part, in particular in the number of blades and/or in a cone angle of the spiral cutting part receiving space and/or in the shape of the blades. The further spiral cutting part may for example be used instead of the cutting part if it is intended to cut different food items into spiral-shaped garlands and/or if it is intended to cut the food item into differently configured spiral-shaped garlands.

### BRIEF DESCRIPTION OF THE DRAWINGS

The drawing illustrates the subject matter of the invention by way of example and schematically, and will be described below on the basis of the figures, wherein elements which are identical or of identical action are normally denoted by the same reference designations even in different exemplary embodiments. In the drawing:

FIG. 1 shows an exemplary embodiment of a food comminution device according to the invention before the utilization thereof using a cutting part,

FIG. 2 shows the exemplary embodiment of a food comminution device according to the invention during the utilization thereof using the cutting part,

FIG. 3 shows the exemplary embodiment of a food comminution device according to the invention during conversion for use of the spiral cutting part,

FIG. 4 shows the exemplary embodiment of a food comminution device according to the invention before the utilization thereof using a spiral cutting part,

FIG. 5 shows the exemplary embodiment of a food comminution device according to the invention during the utilization thereof using the spiral cutting part.

### DETAILED DESCRIPTION OF THE DISCLOSURE

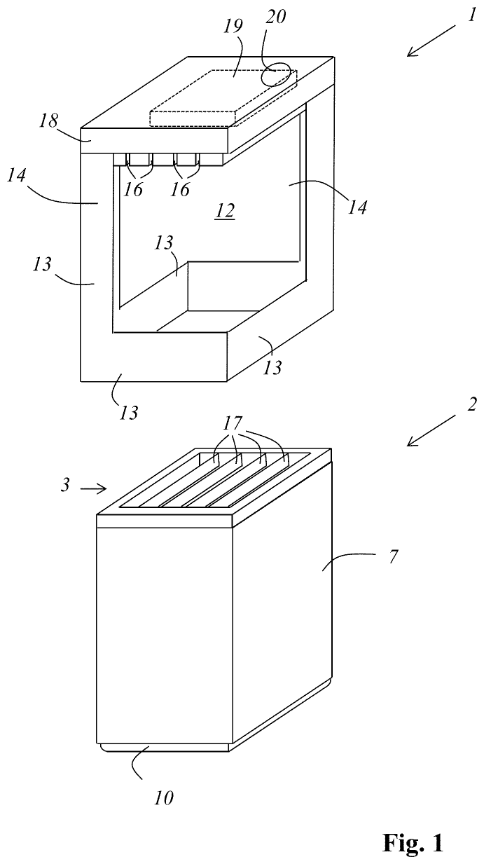

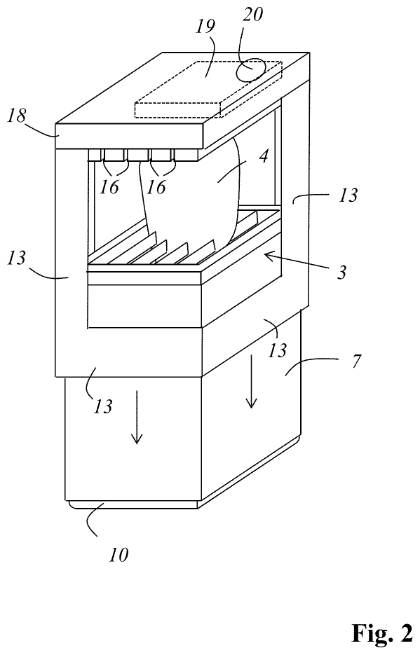

FIGS. 1 to 5 show an exemplary embodiment of a food comminution device according to the invention in different situations. The food comminution device has an actuating part 1 and a base part 2 with a cutting part 3. The actuating part 1 is movably connectable to the base part 2 such that a food item 4 for comminution can be pushed through the cutting part 3 by means of a movement of the actuating part 1 relative to the base part 2, which is illustrated in FIG. 2 and discussed in detail further below.

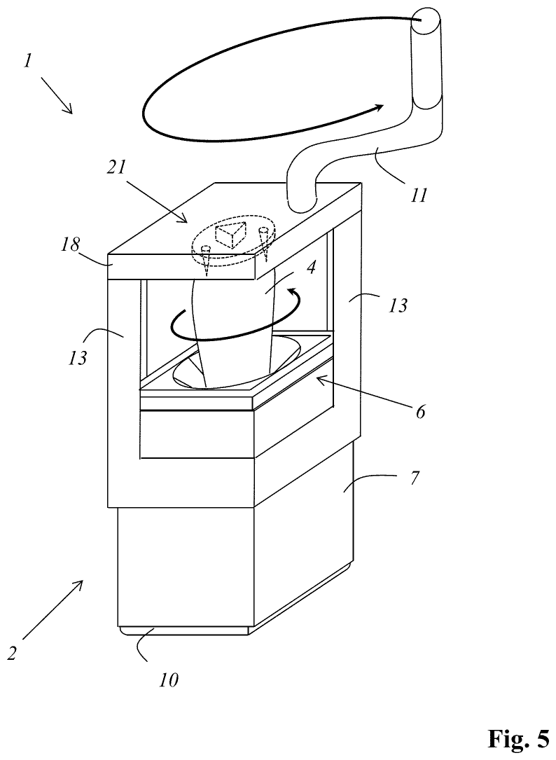

The actuating part 1 has a rotary drive 5, by means of which a food item 4 for comminution can be rotated relative to a spiral cutting part 6 and thus comminuted, which is illustrated in particular in FIG. 5 and discussed in detail further below.

FIG. 1 shows the exemplary embodiment of the food comminution device according to the invention before the utilization thereof using the cutting part 3.

The base part 2 has a container 7. The container 7 serves for collecting the comminuted food item. The container 7 is preferably of translucent or transparent configuration, but this is not illustrated in the figures. If the container is translucent or transparent, the user can directly visually monitor the fill level.

The base part 2 has a receptacle 9 into which selectively the cutting part 3 or the spiral cutting part 6 can be inserted. The receptacle 9 is formed at least partially by the edge region of the container 7, which surrounds an opening of the container 7. The cutting part 3, when inserted into the receptacle 9, lies on an edge 8 of the container 7, whilst a part of the cutting part 3 projects into the container 7. For this purpose, the cutting part 3 has an encircling rabbet 26.

The spiral cutting part 6 has the same outer contour as the cutting part 3. If the spiral cutting part 6 is inserted instead of the cutting part 3 into the receptacle 9, said spiral cutting part is supported on the edge 8 of the container 7, whilst at the same time a part of the spiral cutting part 6 projects into the container 7. For this purpose, the spiral cutting part 6, like the cutting part 3, has an encircling rabbet 26.

The base part 2 has an anti-slip element 10, which is formed from an O-ring, preferably composed of rubber or silicone, at a placement surface. The anti-slip element 10 prevents slippage of the food comminution device relative to a placement surface and in particular makes it possible for the torque that is introduced by way of the hand crank 11 during use of the rotary drive to be supported on the placement surface.

The actuating part 1 has a receiving space 12 into which the base part 2 can at least partially be slid. The receiving space 12 is delimited laterally by a wall 13 that has two apertures 14. The apertures 14 make it possible for a food item 4 for comminution to be introduced into the receiving space 12 before a comminution process, and/or for a food item 4 that is already situated in the receiving space 12 (which food item has for example been introduced through the slide-in opening) to be oriented and positioned.

The shape of the inner contour of the wall 13 of the receiving space 12 and the shape of the outer contour of the base part 2 are identical in a plane perpendicular to the sliding-in direction. In this way, it is advantageously achieved that the actuating part 1 cannot rotate relative to the base part 2 during use of the rotary drive 5. There is merely a degree of play between the base part 2 and the actuating part 1 in order to allow the actuating part 1 to be easily placed over the base part 2 without becoming jammed, and at the same time to allow a food item 4 for comminution to be pushed through the cutting part 3, as illustrated in FIG. 2.

The actuating part 1 has a pressing plunger 15 against which the food item 4 for comminution bears during the movement of the actuating part 1 relative to the base part 2 for the purposes of pushing said item through the cutting part 3. The pressing plunger 15 has grooves 16 into which the cutting blades 17 of the cutting part 3 protrude towards the end of the movement of the actuating part 1 relative to the base part 2. It is hereby ensured that the food item 4 for comminution is completely cut and does not remain stuck between the cutting blades 17.

The pressing plunger 15 is fastened to the upper end of the receiving space 12 and can be removed without the use of tools. A removal of the pressing plunger 15 is necessary if it is intended to use the spiral cutting part 6 instead of the cutting part 3 or if it is intended to use a further cutting part (not illustrated) instead of the cutting part 3. The further cutting part (not illustrated) may differ from the cutting part in particular in the number of cutting blades and/or in the arrangement of the cutting blades and/or in the shape of the cutting blades. Preferably, a further pressing plunger (not illustrated) is provided which is adapted to the further cutting part, such that the cutting blades of the further cutting part can protrude into the grooves of the further pressing plunger. The pressing plunger 15 may however also be configured to be used with different cutting parts. For this purpose, the pressing plunger 15 may have different sets of grooves.

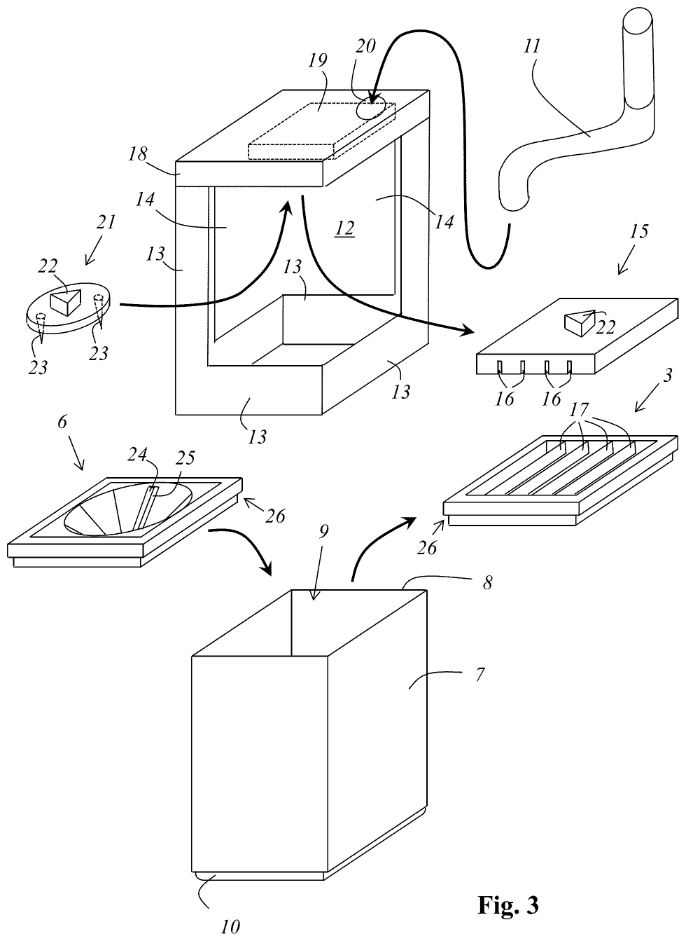

FIG. 3 shows the exemplary embodiment of a food comminution device according to the invention during conversion for use of the spiral cutting part 6 instead of the cutting part 3.

If it is intended to use the spiral cutting part 6 instead of the cutting part 3, the cutting part 3 is removed from the receptacle 9, and the spiral cutting part 6 is instead inserted into the receptacle 9.

The spiral cutting part 6 has a conical spiral cutting part receiving space for the introduction of the food item 4 for comminution, on the wall of which receiving space there is arranged at least one blade 24. The at least one blade 24 is positioned and oriented so as to cut at least one spiral-shaped garland from the food item 4 that is set in rotation by means of the rotary drive 5. Extending adjacent to the blade 24 is an opening 25 through which the spiral-shaped garland passes out of the spiral cutting part receiving space into the container 7.

It is furthermore also necessary for the actuating part 1 to be converted if it is intended to use the spiral cutting part 6 instead of the cutting part 3. As already mentioned, the actuating part 1 has a rotary drive 5 with a hand crank 11. The rotary drive 5 is situated partially in a rotary drive housing 18. A (highly schematically illustrated) transmission 19 is situated in the rotary drive housing 18, to the drive input of which transmission the hand crank 11 can be coupled in torque-transmitting fashion by simply being plugged on by way of a mechanical coupling interface 20.

A driver 21 is couplable to the output of the transmission 19, by means of which driver a rotational movement can be transmitted to a food item 4 for comminution. For coupling onto the output of the transmission 19, the driver 21 preferably has a coupling element 22 configured as a plug-type element. The plug-type element can preferably be plugged with latching and/or clamping action into a counterpart coupling element (not illustrated) of the output of the transmission 19.

The driver 21 has at least one projection 23, specifically spikes, which engage into the food item 4 for comminution in order to establish a rotationally conjoint connection in order that a torque can be transmitted to the food item 4 for comminution.

As an aside: the counterpart coupling element (not illustrated) may in particular also serve for holding the pressing plunger 15 if it is intended to use the cutting part 3 instead of the spiral cutting part 6. For this purpose, the pressing plunger 15 may have a coupling element 22 which is configured to interact with the counterpart coupling element of the output of the transmission 19. The output of the transmission 19 in this case does not transmit any torque to the pressing plunger 15. The coupling element 22 may in particular be configured such that it can be plugged in irrespective of the rotational orientation of the output of the transmission 19.

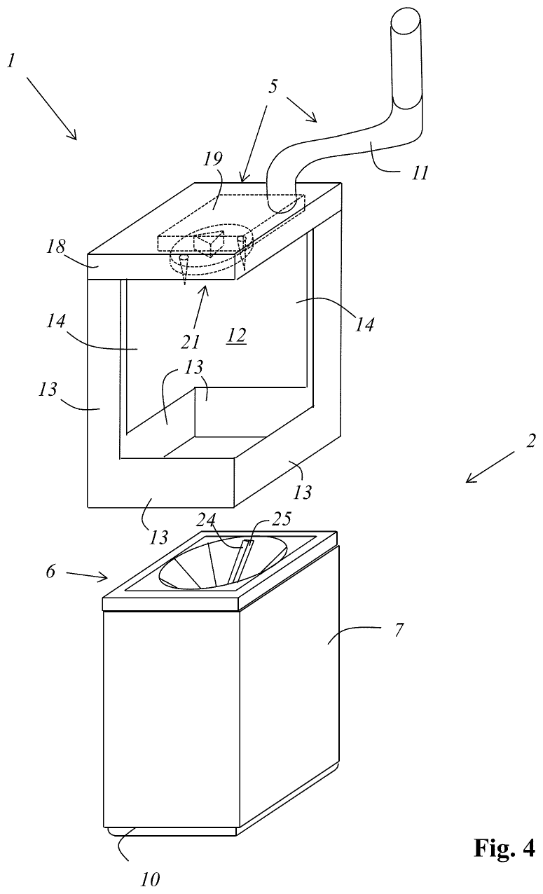

FIG. 4 shows the exemplary embodiment of a food comminution device according to the invention before the utilization thereof using a spiral cutting part 6. In the setting shown, a food item 4 for comminution (not illustrated in this figure) can be inserted and oriented between the driver 21 and the spiral cutting part 6 whilst the actuating part 1 is placed onto the base part 2.

FIG. 5 shows the exemplary embodiment of a food comminution device according to the invention during the utilization thereof using the spiral cutting part 6. Rotary actuation of the hand crank 11 causes the food item 4 for comminution to be set in rotation, and at the same time, the food item 4 for comminution is pushed into the spiral cutting part 6 by virtue of the user exerting a correspondingly directed force from the top downwards onto the actuating part 1 of the food comminution device, which has been placed on a placement surface (not illustrated). In particular, the user can use one hand to hold the actuating part 1 and push downwards whilst at the same time actuating the hand crank 11 using the other hand. As a result of the rotational movement, the blade 24 cuts a spiral-shaped garland from the food item 4 that is set in rotation by means of the rotary drive 5, which garland passes directly into the container 7.

When the food item 4 for comminution has been completely comminuted, the actuating part 1 can be pulled entirely or partially from the base part 2 in order to repeat the process with a further food item 4 for comminution.

If it is intended to use the cutting part 3 again instead of the spiral cutting part 6, another conversion can be performed, in the case of which the steps discussed with regard to FIG. 3 are reversed.

### LIST OF REFERENCE DESIGNATIONS

1 Actuating part
2 Base part
3 Cutting part
4 Food item
5 Rotary drive
6 Spiral cutting part
7 Container
8 Edge
9 Receptacle
10 Anti-slip element
11 Hand crank
12 Receiving space
13 Wall
14 Aperture
15 Pressing plunger
16 Grooves
17 Cutting blades
18 Rotary drive housing
19 Transmission
20 Coupling interface
21 Driver
22 Coupling element
23 Projection
24 Blade
25 Opening
26 Rabbet

What is claimed is:

1. A food comminution device comprising a cutting part (3), a spiral cutting part (6) and a rotary drive (5), wherein food items (4) for comminution can, in order to be comminuted, be selectively pushed through the cutting part (3) or rotated by means of the rotary drive relative to a spiral cutting part (6).

2. The food comminution device as claimed in claim 1, further comprising an actuating part (1) and a base part (2), wherein the actuating part (1) is movably connectable to the base part (2) such that food items (4) for comminution can be pushed through the cutting part (3) by means of a movement of the actuating part (1) relative to the base part (2).

3. The food comminution device as claimed in claim 2, wherein the actuating part (1) has a rotary drive (5) by means of which a food item (4) for comminution can be rotated relative to a spiral cutting part (6).

4. The food comminution device as claimed in claim 3, wherein the food comminution device has a receptacle (9) into which selectively the cutting part (3) or the spiral cutting part (6) can be inserted, or wherein the base part (2) has a receptacle (9) into which selectively the cutting part (3) or the spiral cutting part (6) can be inserted.

5. The food comminution device as claimed in claim 3, wherein the food comminution device has a container (7), or wherein the base part (2) has a container (7).

6.-9. (canceled)

10. The food comminution device as claimed in claim 4, wherein
a. the cutting part (3) can be inserted into the receptacle (9) without the use of tools, and/or wherein
b. the cutting part (3) can be removed from the receptacle (9) again without the use of tools and non-destructively, and/or wherein
c. the spiral cutting part (6) can be inserted into the receptacle (9) without the use of tools, and/or wherein
d. the spiral cutting part (6) can be removed from the receptacle (9) again without the use of tools and non-destructively, and/or wherein
e. the cutting part (3) can be inserted with latching and/or clamping action into the receptacle (9), and/or wherein
f. the spiral cutting part (6) can be inserted with latching, and/or clamping action into the receptacle (9).

11.-12. (canceled)

13. The food comminution device as claimed in claim 3, wherein
a. the base part (2) has a non-circular outer contour in horizontal cross section, and/or wherein
b. the base part (2) is of rectangular, in particular square, configuration in horizontal cross section.

14. (canceled)

15. The food comminution device as claimed in claim 3, wherein the base part (2) and/or the actuating part (1) are of cylindrical configuration at least in certain sections, and/or wherein the base part (2) and/or the actuating part (1) are of cylindrical configuration at least in certain sections, wherein the base area is non-circular, and/or wherein the base part (2) and/or the actuating part (1) are of cuboidal configuration.

16.-19. (canceled)

20. The food comminution device as claimed in claim 3, wherein
a. the actuating part (1) is linearly displaceably connectable to the base part (2), and/or wherein
b. the actuating part (1) is movably connectable to the base part (2) by being configured to be slidable onto the base part (2).

21. (canceled)

22. The food comminution device as claimed in claim 3, wherein the actuating part (1) has a receiving space (12) into which the base part (2) can at least partially be slid, wherein the receiving space (12) is delimited by a wall (13), and wherein the shape of the inner contour of the wall (13) of the receiving space (12) and the shape of the outer contour of the base part (2) are
a. identical in a plane perpendicular to the sliding-in direction and/or
b. non-circular in a plane perpendicular to the sliding-in direction.

23.-27. (canceled)

28. The food comminution device as claimed in claim 3, wherein the food comminution device has a pressing plunger (15) against which the food item (4) for comminution bears during a movement of the actuating part (1) relative to the base part (2) for the purposes of pushing said item through the cutting part (3), or wherein the actuating part (1) has a pressing plunger (15) against which the food item (4) for comminution bears during a movement of the actuating part (1) relative to the base part (2) for the purposes of pushing said item through the cutting part (3).

29. The food comminution device as claimed in claim 28, wherein the pressing plunger (15) has grooves (16) into which the cutting blades (17) of the cutting part (3) protrude during the movement of the actuating part (1) relative to the base part (2).

30.-31. (canceled)

32. The food comminution device as claimed in claim 3, wherein the rotary drive (5) has a transmission (19).

33. The food comminution device as claimed in claim 3, wherein the rotary drive (5) is configured as a manually actuatable drive.

34. The food comminution device as claimed in claim 33, wherein
a. the rotary drive (5) is configured as a crank drive, or wherein
b. the rotary drive (5) has a hand crank (11) which is removable, or wherein
c. the rotary drive (5) is configured as a pull cord drive.

35.-36. (canceled)

37. The food comminution device as claimed in claim 3, wherein the rotary drive (5) is configured as an electric drive.

38. The food comminution device as claimed in claim 3, wherein the food comminution device has a driver (21) which is couplable or coupled to the rotary drive (5) and by means of which a rotational movement can be transmitted to a food item (4) for comminution.

39.-41. (canceled)

42. The food comminution device as claimed in claim 3, wherein
a. the cutting part (3) has at least one cutting blade (17), and/or wherein
b. the cutting part (3) has a cutting grid, and/or wherein
c. the cutting part (3) has multiple mutually parallel cutting blades (17).

43.-44. (canceled)

45. The food comminution device as claimed in claim 3, wherein at least one further cutting part (3) is provided which differs from the cutting part (3) in the number of cutting blades (17) and/or in the arrangement of the cutting blades (17) and/or in the shape of the cutting blades (17) and/or in the configuration of the cutting edge.

46. The food comminution device as claimed in claim 45, wherein a further pressing plunger is provided which is adapted to the further cutting part (3).

47. The food comminution device as claimed in claim 3, wherein the spiral cutting part (6) has at least one cutting blade (24) which is positioned and oriented so as to cut at least one spiral-shaped garland from a food item (4) that is set in rotation by means of the rotary drive (5).

48.-49. (canceled)

50. The food comminution device as claimed in claim 3, wherein the spiral cutting part (6) has a conical spiral cutting part receiving space for the introduction of food items (4), on the receiving space wall of which the at least one blade (24) is arranged.

51. The food comminution device as claimed in claim 3, wherein the spiral cutting part (6) is configured to simultaneously cut multiple spiral-shaped garlands from a food item (4).

52. (canceled)

53. The food comminution device as claimed in claim 3, wherein at least one further spiral cutting part (6) is provided which differs from the spiral cutting part (6) in the number of blades (24) and/or in a cone angle of the spiral cutting part receiving space and/or in the shape of the blades (24).
